(19) United States
(12) Patent Application Publication
(10) Pub. No.: US 2006/0235138 A1
(43) Pub. Date: Oct. 19, 2006

(54) Method of preparing self-emulsified urethane aqueous dispersion and method of preparing core-shell emulsion resin composition using the same

(75) Inventors: Hoon Chung, Suwon-si (KR); Seung-Young Choi, Seoul (KR); Jong-Myung Hong, Anyang-si (KR)

Correspondence Address: MAYER, BROWN, ROWE & MAW LLP, 1909 K STREET, N.W., WASHINGTON, DC, 20006, US

(73) Assignee: DPI CO., LTD.

(21) Appl. No.: 11/222,842

(22) Filed: Sep. 12, 2005

(30) Foreign Application Priority Data
Apr. 19, 2005 (KR) 10-2005-0032488

(51) Int. Cl. C08G 18/08

(52) U.S. Cl. 524/507; 523/201

(57) ABSTRACT

In order to prepare an alkaline expansive core-shell emulsion resin composition applicable to an aqueous base coat paint composition for an automobile using a urethane aqueous dispersion as an emulsifying agent, first, anionic urethane aqueous dispersion having an acid value of about 50-150 mgKOH/g is prepared. Then, an alkaline expansive core-shell emulsion resin is prepared by using the urethane aqueous dispersion as an emulsifying agent. Flowing or stain after coating may be prevented when using a paint composition prepared by using thus prepared emulsion resin. Water-resistance of a coating layer and alignment of metallic particles are improved.

### CROSS REFERENCE TO RELATED APPLICATION

This application relies for priority upon Korean Patent Application No. 2005-32488 filed on Apr. 19, 2005, the contents of which are herein incorporated by reference in its entirety.

### BACKGROUND OF THE INVENTION

1. Field of the Invention

The present invention relates to a method of preparing a self-emulsified urethane aqueous dispersion and a method of preparing a core-shell emulsion resin composition using the self-emulsified urethane aqueous dispersion and more particularly, the present invention relates to a method of preparing an alkaline expansive core-shell emulsion resin composition appropriate for an aqueous base coat composition of an automobile.

2. Description of the Related Arts

Recently, domestic and foreign researches on a resin for a paint composition are concerned with a development on a paint composition having a low contamination and a low toxicity and saving resources considering the environment and on a polymer having a high performance and a high function along with various usages and properties. In particular, researches on reducing the amount of an organic solvent included in the composition also are actively performed. A prime motive of these researches is an exhaust restriction of an organic solvent to reserve the environment. Two representative restrictions on the exhaustion of the organic solvent are a restriction on volatile organic compounds of American Environmental Protection Agency and a Clean Air Act (TA-Luft) of Germany. The former defines a guide line on the amount of the organic solvent included in a coating material and the latter restricts the amount of the organic solvent exhausted from a coating material required when coating one automobile. About 20% of the exhausting amount of CO₂ in the whole world is considered being generated through a coating industry concerning the organic solvent and the combustion by means of a drying oven. Therefore, the coating industry is the main factor of the environmental contamination and is the target to be managed.

Generally, the coating of an automobile includes a coating of a primer paint composition for protecting a body of the automobile from corrosion, an intermediate coating to heighten an elastic strength of a coating layer on the primer coat, a top coating of a base coat to impart various colors and finally a coating of a clear coat for the gloss and scratch-resistance of the automobile. The primer paint composition has been applied since 1970 and is an aqueous paint composition using water as a solvent. However, the remaining intermediate coat, top coat and clear coat include volatile organic compound (VOC) as the solvent, which is a main factor of the environmental contamination. Accordingly, an effort to replace the organic solvent of these remaining coating compositions with aqueous solvent is actively conducted. Among the paint compositions, since the base coat includes the largest amount of the organic solvent, researches on an aqueous base coat is particularly active.

U.S. Pat. No. 6,552,117 discloses an aqueous base coat composition that is obtained by mixing an alkaline expansive core-shell emulsion with a urethane aqueous dispersion and has a good water-resistance. Korean Patent No. 0163276 discloses a method of preparing a non-ionic urethane-acryl aqueous dispersion using hydrophilic polyester instead of an anionic urethane aqueous dispersion, which is appropriate for an aqueous base coat. In addition, U.S. Pat. No. 4,978,708 discloses an example of applying the aqueous urethane dispersion as a binder of an aqueous base coat.

However, since the aqueous coating compositions disclosed in the above-described papers include water as the solvent instead of the organic solvent, the surface hardening after the coating is remarkably deteriorated to generate problems concerning a flowing and a surface stain. To solve the problems concerning the flowing and the surface stain, an auxiliary additive including a viscosity increasing agent to control the flexibility of the paint composition is added. The flowing and metallic alignment can be controlled through the addition of the auxiliary additive including the viscosity-increasing agent. However, the water-resistance is deteriorated when an appropriate application is not conducted.

### SUMMARY OF THE INVENTION

The present invention provides a method of preparing a self-emulsified urethane aqueous dispersion for preparation of an emulsion resin composition preventing flowing and stain while improving metallic alignment.

The present invention also provides a method of an alkaline expansive core-shell emulsion resin composition using the above self-emulsified urethane aqueous dispersion, which is applicable to an aqueous base coat composition of an automobile.

In one aspect of the present invention, there is provided a method of preparing a self-emulsified urethane aqueous dispersion for a core-shell emulsion resin composition. First, a pre-polymer including an isocyanate functional group at a terminal portion of the pre-polymer is prepared by reacting a di-fuctional isocyanate compound with polycarbonate polyol having a molecular weight of about 1000-2000 and a compound having at least two hydroxyl functional groups and one carboxyl functional group. Then, the pre-polymer is dispersed into an aqueous solution of a tertiary amine and then the chain of the pre-polymer is extended using one of primary amine and secondary amine.

In another aspect of the present invention, there is provided a method of preparing an alkaline expansive core-shell emulsion resin composition. First, a core is formed through reacting a self-emulsified urethane aqueous dispersion according to the above-described method as an emulsifying agent and a vinyl monomer to obtain a pre-emulsion and then emulsion polymerization is carried out. Then, a hydrophilic shell portion is formed through dropping a monomer mixture including a hydrophilic vinyl monomer onto thus formed core.

According to the present invention, the self-emulsified urethane aqueous dispersion is used as an emulsifying agent to form an alkaline expansive core-shell emulsion resin through an emulsifying polymerization. This emulsion is used as a binder resin of an aqueous base coat paint composition of an automobile to prevent flowing or stain after coating. The water-resistance of a dried coating layer and an alignment of metallic particles may be improved.

### DESCRIPTION OF THE INVENTION

Hereinafter, the present invention will be described in detail.

The emulsion resin composition according to the present invention is prepared by an emulsion polymerization method using a self-emulsified urethane aqueous dispersion having an acid value of about 50-150 mgKOH/g and prepared by introducing a compound including polycarbonate having a molecular weight of about 1000-2000 and including at least two hydroxyl functional groups and one carboxyl functional group at the main chain, as an emulsifying agent.

An alkaline expansive core-shell emulsion resin composition including the self-emulsified urethane aqueous dispersion is prepared mainly according to two following steps.

(1) Preparation of a self-emulsified urethane aqueous dispersion used as an emulsifying agent for an emulsion polymerization: A pre-polymer including an isocyanate functional group at the terminal portion of the pre-polymer is prepared by reacting di-functional isocyanate compound with polycarbonate polyol having a molecular weight of about 1000-2000, with a compound including at least two hydroxyl functional groups and one carboxyl functional group. The pre-polymer is dispersed into an aqueous solution of a tertiary amine and then the chain of the pre-polymer is extended using a primary amine or a secondary amine. Thus formed self-emulsified urethane aqueous dispersion has an acid value of about 50-150 mgKOH/g and is applied as an emulsifying agent of an alkaline expansive core-shell emulsion.

(2) Preparation of an alkaline expansive core-shell emulsion by an emulsion polymerization using the self-emulsified urethane aqueous dispersion as an emulsifying agent: Pre-emulsion of a vinyl monomer is prepared through an emulsion polymerization using the emulsifying agent to form a core, and then a hydrophilic shell portion is formed by dropping a monomer mixture including hydrophilic vinyl monomer.

The emulsion resin prepared by the above-described method expands through an addition of an alkaline compound due to the hydrophilic portion of the shell portion to control the flexibility of an aqueous paint composition.

First, a method of preparing the self-emulsified urethane aqueous dispersion will be described in detail below.

The self-emulsified urethane aqueous dispersion applied as the emulsifying agent of the alkaline expansive core-shell emulsion resin composition, includes polycarbonate polyol having a number average molecular weight of about 1000-2000, a compound having one di-functional hydroxyl functional group and one carboxyl functional group, di-functional isocyanate, N-methylpyrrolidone, a neutralizing agent of a tertiary amine for neutralizing carboxylic acid, and a primary or a secondary amine compound for extending chain and water. The self-emulsified urethane aqueous dispersion applied as an emulsifying agent of the alkaline expansive core-shell emulsion resin composition is prepared according to following steps.

(1) Preparation of pre-polymer including an isocyanate functional group at a terminal portion of the pre-polymer and a hydrophilic carboxyl functional group at a side chain portion of the pre-polymer: polycarbonate polyol, a compound including one di-functional hydroxyl functional group and one carboxyl functional group, di-functional isocyanate and N-pyrrolidone are added into a flask and the temperature is increased to about 80° C. The reaction is kept until a desired NCO equivalent is accomplished.

(2) Dispersing the pre-polymer into water and preparing an aqueous dispersion through an extension of chain: The pre-polymer is added slowly into an aqueous solution of a tertiary amine while stirring the solution in a rapid speed to prepare an aqueous dispersion having an active isocyanate functional group. Immediately after that, a primary amine compound or a secondary amine compound for extending the chain is added. The temperature is increased to about 50° C. and the reaction is kept until an IR peak at about 2273 cm⁻¹ corresponding to an isocyanate functional group (—NCO) disappears by using an infrared spectroscopy. A urethane aqueous dispersion having an acid value of about 50-150 mgKOH/g, appropriate for an emulsion polymerization of an alkaline expansive core-shell is prepared.

When the acid value of the urethane aqueous dispersion applicable for the alkaline expansive core-shell emulsion polymerization is less than about 50 mgKOH/g, an anionic urethane aqueous dispersion is obtainable. However, a stable pre-emulsion is not obtainable when using thus produced aqueous dispersion as an emulsifying agent and so an alkaline expansive core-shell emulsion resin is not obtainable. When the acid value of the urethane aqueous dispersion applicable for the alkaline expansive core-shell emulsion exceeds about 150 mgKOH/g, and when an alkaline expansive core-shell emulsion resin is prepared by using thus produced aqueous dispersion as an emulsifying agent, a dried layer of resin composition including the resin having an inferior water-resistance is formed. Therefore, the preferred acid value of the urethane aqueous dispersion appropriate for the emulsion polymerization of the alkaline expansive core-shell emulsion resin is in the range of about 50-150 mgKOH/g, and more preferably, is in the range of about 70-120 mgKOH/g.

Examples of the isocyanate compound may include 1,6-hexamethylene diisocyanate, isophorone diisocyanate, 4,4-bis isocynate cyclohexyl methane, etc. These can be used alone or in a mixture thereof.

Examples of the compound including one di-functional hydroxyl functional group and one carboxyl functional group, for providing hydrophilic side chain may include dimethylol propionic acid, dimethylol butanoic acid, etc. These can be used alone or in a mixture thereof.

Examples of the neutralizing agent to disperse into water the pre-polymer including a hydrophilic portion at the side chain portion of the pre-polymer and an isocyanate functional group at the terminal portion of the pre-polymer, may include triethyl amine as a tertiary amine, ammonia, etc. These can be used alone or in a mixture thereof.

In order to increase the molecular weight of the aqueous dispersion of the pre-polymer, a chain extending amine material inducing ethylene diamine, hydrazine, isophorone diamine, morpholin, etc., can be used. The amount of the added amine is determined so as to adjust the molar ratio of NCO/NH in a range of about 1/0.8 to about 1/0.95.

When the molar ratio of NCO/NH is less than about 0.8, a urea structure is produced due to water and the reaction time is lengthened. When the molar ratio exceeds about 1/0.95, pH during preparing the alkaline extensive core-shell emulsion resin is increased because of the presence of free amine, thereby affecting the reactivity.

Hereinafter, the method of preparing the alkaline expansive core-shell emulsion resin composition will be described in detail below.

The alkaline expansive core-shell emulsion of the present invention uses about 5-30% by weight of a urethane aqueous dispersion based on the amount of the total monomer, and more preferably uses about 10-20% by weight of the urethane aqueous dispersion as an emulsifying agent to implement an emulsion polymerization.

The alkaline expansive core-shell emulsion is a copolymer prepared by two or more steps.

Through the first step, about 60-90 parts by weight of a monomer mixture ‘A’ based on about 100 parts by weight of addition polymer, is copolymerized including about 60-99% by mole of a cycloalkyl methacrylate compound including a cycloalkyl group of about four to twelve carbon atoms and about 1-40% by mole of copolymerizable monoalkylene unsaturated monomer. The sum of these two compounds is always about 100% by mole.

Through the second step, about 10-40 parts by weight of a monomer mixture ‘B’ based on about 100 parts by weight of addition polymer is continuously copolymerized including about 10-60% by mole of methacrylic acid and about 40-90% by mole of other copolymerizable mono-alkylene unsaturated monomer. The sum of these two compounds is always about 100% by mole. Due to a presence of carboxyl functional group induced from a portion of ionized methacrylic acid, the alkaline expansive core-shell emulsion polymer may be prepared.

Preferably, the addition polymer is obtained through copolymerizing about 70-90 parts by weight of the monomer mixture ‘A’ and about 10-30 parts by weight of the monomer mixture ‘B’. Selectively, other monomer mixture ‘A’ and/or ‘B’ may be used continuously.

Examples of the cycloalkyl methacrylate compound including cycloalkyl having four to twelve carbon atoms and appropriate for the preparation of the monomer mixture ‘A’, may include butyl acrylate, butyl methacrylate, 2-ethylhexyl acrylate, 2-ethylhexyl methacrylate, octyl acrylate, octyl methacrylate, isobornyl acrylate, isobornyl methacrylate, dodecyl acrylate, dodecyl methacrylate, etc. These can be used alone or in a mixture thereof. The monomer mixture ‘A’ preferably includes about 60-99% by mole of the above-described cycloalkyl methacrylate and more preferably includes about 80-90% by mole of the cycloalkyl methacrylate. Preferred monomer may include butyl acrylate, butyl methacrylate, or a mixture thereof.

Appropriate copolymerizable mono-alkylene unsaturated monomer for the preparation of the monomer mixture ‘A’ may include an alkyl methacrylate compound including an alkyl group having four or less carbon atoms, for example, methyl methacrylate, methyl acrylate, ethyl acrylate, ethyl methacrylate, propyl acrylate, propyl methacrylate or isopropyl methacrylate; a methacrylate compound including an ether functional group, for example, 2-methoxyethyl methacrylate, 2-ethoxyethyl methacrylate or 3-methoxypropyl acrylate; and a hydroxyalkyl methacrylate compound, for example, 2-hydroxyethyl acrylate, 2-hydroxyethyl methacrylate, 2-hydroxypropyl acrylate, 2-hydroxypropyl methacrylate, 4-hydroxybutyl acrylate, 6-hydroxyhexyl acrylate, p-hydroxy cyclohexyl acrylate, p-hydroxy cyclohexyl methacrylate or hydroxy polyethylene glycol methacrylate. These can be used alone or in a mixture thereof. A maximum amount of the unsaturated monomer in the monomer mixture is about 40% by mole and more preferably, is about 10-20% by mole.

More preferably, the alkyl methacrylate compound, for example, methyl acrylate, methyl methacrylate, ethyl acrylate or ethyl methacrylate; and the hydroxy alkyl methacrylate compound, for example, 2-hydroxy ethyl acrylate, 2-hydroxy ethyl methacrylate, 2-hydroxypropyl acrylate or 2-hydroxypropyl methacrylate, may be used. These can be used alone or in a mixture thereof.

Copolymerizable mono-alkylene unsaturated monomer used for the preparation of the monomer mixture ‘B’ may include a mono-vinyl aromatic carbohydrate compound, for example, styrene, vinyl toluene or α-methyl styrene vinyl naphthalene; a nitrile compound, for example, acrylonitrile or methacrylonitrile; an acryl or methacryl ester compound, for example, methyl methacrylate, methyl acrylate, ethyl acrylate, ethyl methacrylate, propyl acrylate, propyl methacrylate, isopropyl acrylate, butyl acrylate, butyl methacrylate or 2-ethylhexyl acrylate; a hydroxyl alkyl methacrylate compound, for example, 2-hydroxy ethyl acrylate, 2-hydroxy ethyl methacrylate, 2-hydroxy propyl acrylate, 2-hydroxy propyl methacrylate, 4-hydroxy butyl acrylate, 6-hydroxy hexyl acrylate or p-hydroxy cyclohexyl acrylate; and a methacrylate compound including an ether functional group, for example, 2-methoxy ethyl methacrylate, 2-ethoxy ethyl methacrylate, 3-methoxy propyl acrylate hydroxy polyethylene glycol methacrylate or hydroxy polypropylene glycol methacrylate. These can be used alone or in a mixture thereof.

More preferably, methyl acrylate, methyl methacrylate, butyl acrylate, butyl methacrylate or a mixture thereof may be used. The monomer mixture ‘B’ preferably includes about 10-60% by mole of methacrylic acid and about 40-90% by mole of polymerizable mono-alkylene unsaturated monomer, and more preferably includes about 20-40% by mole of methacrylic acid and about 60-80% by mole of polymerizable mono-alkylene unsaturated monomer.

For the emulsion polymerization, a commonly used amount of the conventional radical initiator can be used. Appropriate radical initiator may include an aqueous initiator, for example, ammonium persulfate, sodium persulfate, potassium persulfate, t-butyl hydroperoxide, and the like.

The copolymerization of the monomer mixture is commonly implemented at a temperature of about 60-100° C., preferably at a temperature of about 75-85° C., under an inert gas atmosphere such as nitrogen at an atmospheric pressure. However, the polymerization selectively can be implemented at a high pressure. The reaction condition for the monomer mixtures ‘A’ and ‘B’ should be selected so that the functional groups included in the monomer mixture should not react other than the unsaturated bond.

About 80-100% of the carboxyl functional group induced from acrylic acid and/or methacrylic acid is neutralized through the addition of a neutralizing agent according to the present invention. An appropriate neutralizing agent for the carboxyl functional group may include ammonia and amine, for example, N,N-dimethyl ethanolamine, N,N-diethyl ethanolamine, 2-dimethyl-amino-2-methyl-1-propanol, triethyl amine, morpholine and the like. The neutralization of the carboxyl functional group is preferably implemented after the polymerization.

Hereinafter, the present invention is described in detail with reference to the following examples. The examples are given solely for the purpose of illustration and are not to be construed as limitations of the present invention, as many variations thereof are possible without departing from the spirit and scope of the invention.

Synthesis of Self-Emulsified Urethane Aqueous Dispersion

### EXAMPLE 1

About 67 parts by weight of dimethylol propionic acid, about 20 parts by weight of polycarbonate polyol (molecular weight 2000), about 187.11 parts by weight of N-methylpyrrolidone and about 0.2 part by weight of dibutyl tin laurate were added into a reaction vessel and a temperature was increased to about 60° C. to completely dissolve dimethylol propionic acid. About 200 parts by weight of 4,4-bis isocyanate cyclohexyl methane was slowly added while paying attention of an exothermic reaction. After completing the addition, the reaction temperature was elevated to about 80° C. and kept until NCO equivalent reaches to about 960 to prepare a pre-polymer. About 404 parts by weight of ion exchanged water and about 50.5 parts by weight of triethyl amine were added into another reaction vessel and the temperature was elevated to about 30° C. while stirring in a rapid speed. The pre-polymer was added slowly over about ten minutes to obtain an aqueous dispersion. Then, a mixture of about 8.91 parts by weight of about 80% hydrazine hydrate and about 41 parts by weight of ion exchanged water was added. The reaction was kept until NCO peak disappeared by means of an infrared spectroscopy to extend the chain. A self-emulsified urethane aqueous dispersion having an acid value of about 94 mgKOH/g and a solid content of about 30%, which was appropriate for the preparation of an alkaline expansive core-shell emulsion resin, was prepared.

Preparation of Alkaline Expansive Core-Shell Emulsion Resin

### EXAMPLE 2

About 120 g of ion exchanged water was added into a 0.5 L flask and the temperature was elevated to about 80° C. About 50 g of de-ionized water and about 10 g of the urethane aqueous dispersion prepared from Example 1 were added into a beaker and stirred. Then, about 22 g of n-butyl methacrylate, about 20 g of n-butyl acrylate, about 24 g of methyl methacrylate, about 3 g of 2-hydroxy ethyl acrylate and about 1 g of methacrylic acid were added one by one to prepare a monomer pre-emulsion. About 10% of thus obtained monomer pre-emulsion was added into the flask as a seed. After about five minutes, about 0.5 g of ammonium persulfate dissolved in about 5 g of de-ionized water was added. After about ten minutes, the monomer pre-emulsion was added drop by drop for about three hours and a mixture solution of about 6 g of methacrylic acid, about 16 g of methyl methacrylic acid and about 8 g of 2-hydroxy ethyl acrylate was added drop by drop for two hours. After completing the dropping, the reaction was kept for about one hour and about 7.3 g of dimethyl ethanol amine diluted in about 50 g of de-ionized water at a temperature of about 60° C. or less was slowly added to prepare an alkaline expansive core-shell emulsion.

Preparation of Alkaline Expansive Core-Shell Emulsion Resin

### EXAMPLE 3

About 120 g of ion exchanged water was added into a 0.5 L flask and the temperature was elevated to about 80° C. About 50 g of de-ionized water and about 20 g of the urethane aqueous dispersion prepared from Example 1 were added into a beaker and stirred. Then, about 22 g of n-butyl methacrylate, about 20 g of n-butyl acrylate, about 24 g of methyl methacrylate, about 3 g of 2-hydroxy ethyl acrylate and about 1 g of methacrylic acid were added one by one to prepare a monomer pre-emulsion. About 10% of thus obtained monomer pre-emulsion was added into the flask as a seed. After five minutes, about 0.5 g of ammonium persulfate dissolved in about 5 g of de-ionized water was added. After ten minutes, the monomer pre-emulsion was added drop by drop for three hours and a mixture solution of about 6 g of methacrylic acid, about 16 g of methyl methacrylic acid and about 8 g of 2-hydroxy ethyl acrylate was added drop by drop for two hours. After completing the dropping, the reaction was kept for one hour and about 7.3 g of dimethyl ethanol amine diluted in about 50 g of de-ionized water at a temperature of about 60° C. or less was slowly added to prepare an alkaline expansive core-shell emulsion.

### COMPARATIVE EXAMPLE 1

The same procedure described in Example 2 was implemented except that about 10 g of the urethane aqueous dispersion was replaced with about 2 g of sodium dodecyl benzene sulfonic acid to prepare an alkaline expansive core-shell emulsion.

Preparation of Aluminum Pigment Dispersion

### PREPARATION EXAMPLE 1

HYDROLAN WHH 9157 (trade name manufactured by Ekart Co., Ltd. In Germany) was added into the substantially same amount of butyl cellosolve and stirred to prepare a homogeneous dispersion.

Preparation of Silver-Base Paint Composition

### PREPARATION EXAMPLE 2

Into about 180 g of the resin prepared from Example 2, was added about 13 g of CYMEL-303 resin purchased from Cytech Co., Ltd. in U.S. While stirring, about 40 g of the aluminum pigment dispersion prepared from Preparation Example 1 was slowly added. The stirring was continued for ten minutes and about 2 g of VISCALEX HV-30AB purchased from Ciba Co., Ltd. in Swiss and diluted in about 18 g of de-ionized water was added. After that, about 5 g of n-butanol was added and about 0.6 g of dimethyl ethanolamine was added to adjust the pH value and to prepare a silver paint composition.

### PREPARATION EXAMPLE 3

Into about 180 g of the resin prepared from Example 3, was added about 13 g of CYMEL-303 resin purchased from Cytech Co., Ltd. in U.S. While stirring, about 40 g of the aluminum pigment dispersion prepared from Preparation Example 1 was slowly added. The stirring was continued for ten minutes and about 2 g of VISCALEX HV-30AB purchased from Ciba Co., Ltd. in Switzerland and diluted in about 18 g of de-ionized water was added. Thereafter about 5 g of n-butanol was added and about 0.6 g of dimethyl ethanolamine was added to adjust the pH value and to prepare a silver paint composition.

### COMPARATIVE PREPARATION EXAMPLE 1

Into about 180 g of the resin prepared from Comparative Example 1, was added about 13 g of CYMEL-303 resin purchased from Cytech Co., Ltd. in U.S. While stirring, about 40 g of the aluminum pigment dispersion prepared from Preparation Example 1 was slowly added. The stirring was continued for ten minutes and about 2 g of VISCALEX HV-30AB purchased from Ciba Co., Ltd. in Switzerland and diluted in about 18 g of de-ionized water was added. Thereafter, about 5 g of n-butanol was added and about 0.6 g of dimethyl ethanolamine was added to adjust the pH value and to prepare a silver paint composition.

Some tests for the silver-base paint compositions prepared from Preparation Examples 2 to 3 and Comparative Preparation Example 1 were implemented.

On zinc phosphate treated steel sheet having a size of about 150×70×0.8 mm, RF-6500 GRAY (trade name of cationic electrodepositing paint composition manufactured by DAC Co., Ltd. in Korea) was sprayed so that the thickness of a dried coating layer became about 20 μm and then heated at a temperature of about 150° C. for twenty minutes.

On thus formed electrodeposited coating layer, KES-100 (trade name of melamine curing type polyester-based resin intermediate coat manufactured by DAC Co., Ltd. in Korea) was air sprayed and then was heated to a temperature of about 150° C. for twenty minutes.

On the intermediate coating layer, the silver-base paint composition prepared by Preparation Examples 2 and 3 and Comparative Example 1 was coated twice so that the thickness of dried coating layer became about 15 μm. After the coating, the coating layer was dried at a temperature of about 80° C. for two minutes to form a base coating layer. Thus formed test sample was cooled to the room temperature and then, HMC 1800 CLEAR (trade name of melamine curing type acryl-based resin clear paint composition manufactured by DAC Co., Ltd. in Korea) was air sprayed as a clear paint composition to a thickness of about 40 μm. Then, the sample was heated to a temperature of about 140° C. for twenty minutes to obtain a test sample for estimating physical properties.

Among the physical properties, a test on water-resistance was conducted after dipping the test sample into water at a temperature of about 40-50° C. for one week. The appearance of the sample was observed and a crosscut adhering test of the coating layer was conducted. In order to estimate objectively the appearance of the coating layer, the alignment of the aluminum particles, that is, flip-flop property of the coating layer was estimated. IV value was measured using IV METER (trade name manufactured by Kansai Paint Co., Ltd. in Japan). A passing mark was 240 or over.

TABLE 1
Measured Result of Water-Resistance and Flip-Flop Property

| | Prepara- | Prepara- | Comparative | |
|---|---|---|---|---|
| | tion | tion | Preparation | |
| Coating layer | Example 2 | Example 3 | Example 1 | Note |
| 40° C. water- | Excellent | Excellent | Excellent | |
| resistance | | | | |
| 50° C. water- | Excellent | Excellent | Minute blister | |
| resistance | | | at surface | |
| Adhesiveness | 100/100 | 100/100 | 98/100 | After 50° |
| | | | | C. water- |
| | | | | resistance |
| | | | | test, |
| | | | | cross-cut |
| | | | | and tape |
| | | | | adhesive- |
| | | | | ness test |
| Flip-flop | 255 | 260 | 234 | Passing |
| property | | | | mark: 240 |
| (IV value) | | | | |

As can be noted from Table 1, the coating layer formed by using the paint composition of Preparation Examples 2 and 3, prepared by using a urethane aqueous dispersion as an emulsifying agent, exhibits excellent water-resistance at a high temperature. However, blister is observed at the surface portion of the coating layer after the 50° C. water-resistance test for the coating layer formed by Comparative Preparation Example 1 using the resin prepared by Comparative Example 1 using a general anionic emulsifying agent.

The flip-flop property value of the effect pigment, representing an objective value of good appearance because of an excellent alignment of an aluminum pigment is also relatively high for the coating layer formed by Preparation Examples 2 and 3 using the urethane aqueous dispersion as an emulsifying agent.

The coating layer formed by Comparative Preparation Example 1 exhibits relatively inferior flip-flop property value. Therefore, the urethane aqueous dispersion can be effectively used as an emulsifying agent for the alignment of the metallic agent.

An aqueous base coat paint composition for an automobile prepared by using an alkaline expansive core-shell emulsion resin composition including a self-emulsified urethane aqueous dispersion prepared by the present invention, controls flexibility, prevents flowing and stain, improves aligning property of metallic pigments and increases water-resistance deteriorated when employing a general emulsifying agent.

While the present invention is described in detail referring to the attached embodiments, various modifications, alternate constructions and equivalents may be employed without departing from the true spirit and scope of the present invention.

What is climed is:

1. A method of preparing a self-emulsified urethane aqueous dispersion for a core-shell emulsion resin composition comprising:
preparing a pre-polymer including an isocyanate functional group at a terminal portion of the pre-polymer by reacting a di-fuctional isocyanate compound with polycarbonate polyol having a molecular weight of about 1000 to about 2000 and a compound having at least two hydroxyl functional groups and one carboxyl functional group; and
dispersing the pre-polymer into an aqueous solution of a tertiary amine and then extending chain of the pre-polymer using one of a primary amine and a secondary amine.

2. The method of claim 1, wherein the isocyanate compound comprises at least one selected from the group consisting of 1,6-hexamethylene diisocyanate, isophorone diisocyanate and 4,4-bis isocyanate cyclohexyl methane.

3. The method of claim 1, wherein the compound having at least two hydroxyl functional groups and one carboxyl functional group comprises at least one selected from the group consisting of dimethylol propionic acid and dimethylol butanoic acid.

4. The method of claim 1, wherein the tertiary amine to disperse the pre-polymer comprises at least one selected from the group consisting of triethyl amine and ammonia.

5. The method of claim 1, wherein the primary and secondary amines to extend the chain of the pre-polymer comprises at least one selected from the group consisting of ethylene diamine, hydrazine, isophorone diamine and morpholine.

6. The method of claim 1, wherein an acid value of the aqueous dispersion is in a range of about 50 mgKOH/g to about 150 mgKOH/g.

7. The method of claim 1, wherein an added amount of the primary and secondary amines to extend the chain of the pre-polymer is determined so as to adjust the molar ratio of NCO/NH in a range of about 1/0.8 to about 1/0.95.

8. A method of preparing an alkaline expansive core-shell emulsion resin composition comprising:
forming a core through reacting a self-emulsified urethane aqueous dispersion according to claim 1 as an emulsifying agent and a vinyl monomer to obtain a pre-emulsion and then emulsion polymerizing; and
forming a hydrophilic shell portion by dropping a monomer mixture including a hydrophilic vinyl monomer onto thus formed core.

9. The method of claim 8, wherein an added amount of the self-emulsified urethane aqueous dispersion is in a range of about 5% by weight to 30% by weight based on a total amount of the monomer.

10. The method of claim 8, wherein the vinyl monomer for forming the core portion includes a monomer mixture of about 60% by mole to about 99% by mole of a cycloalkyl methacrylate compound including a cycloalkyl functional group having four to twelve carbon atoms and about 1% by mole to about 40% by mole of a copolymerizable mono-alkylene unsaturated monomer.

11. The method of claim 8, wherein the hydrophilic vinyl monomer for forming the shell portion comprises a monomer mixture of about 10% by mole to about 60% by mole of methacrylic acid and about 40% by mole to about 90% by mole of a copolymerizable mono-alkylene unsaturated monomer.

12. The method of claim 8, wherein an amount of the vinyl monomer for forming the core portion is in a range of about 60 parts by weight to about 90 parts by weight and an amount of the hydrophilic vinyl monomer for forming the shell portion is in a range of about 10 parts by weight to about 40 parts by weight.

13. The method of claim 8, wherein a neutralizing agent is added into a carboxyl functional group induced from acrylic acid and/or methacrylic acid of the alkaline expansive core-shell emulsion resin to neutralize and expand by at least about 80% to about 100%.

14. The method of claim 13, wherein the neutralizing agent comprises at least one selected from the group consisting of ammonia, N,N-dimethyl ethanolamine, N,N-diethyl ethanolamine, 2-(dimethyl)-amino-2-methyl-1-propanol, triethyl amine and morpholine.

15. The method of claim 8, wherein the emulsion polymerization is implemented at a temperature range of about 60° C. to about 100° C. and under an atmosphere of an inert gas including nitrogen.

16. A base coat composition comprising an alkaline expansive core-shell emulsion resin according to claim 8.
